(19) United States
(12) Patent Application Publication
(10) Pub. No.: US 2021/0173145 A1
(43) Pub. Date: Jun. 10, 2021

(54) STRUCTURES AND METHODS FOR ALIGNING AND SECURING OPTICAL FIBERS IN PHOTONIC INTEGRATED CIRCUIT (PIC) PACKAGES USING VARIOUS ADHESIVES

(71) Applicant: GLOBALFOUNDRIES U.S. Inc., Santa Clara, CA (US)

(72) Inventors: Benjamin V. Fasano, New Windsor, NY (US); Jorge A. Lubguban, Danbury, CT (US); Sarah H. Knickerbocker, Poughkeepsie, NY (US); Tracy A. Tong, Wallkill, NY (US)

(21) Appl. No.: 16/703,387

(22) Filed: Dec. 4, 2019

(51) Int. Cl. G02B 6/122; G02B 6/12; G02B 6/38

(52) U.S. Cl. CPC G02B 6/1225; G02B 2006/1213; G02B 6/3861; G02B 6/12011

(57) ABSTRACT

Photonic integrated circuit (PIC) packages include a PIC die. The PIC die includes a waveguide(s) positioned on the PIC die, and a groove(s) formed in a surface of the PIC die. The groove(s) corresponds to and is positioned directly adjacent the waveguide(s). The PIC package also includes an optical fiber(s) operatively coupled to the waveguide(s) of the PIC die. The optical fiber(s) are positioned in the groove(s) of the PIC die and include an end positioned adjacent the waveguide(s). Additionally, the PIC package includes a plate positioned over a section of the optical fiber(s), and the plate includes a first edge positioned adjacent the waveguide(s) of the PIC die, and a second edge positioned opposite the first edge. The PIC package also includes a first adhesive disposed along the second edge of the plate and a second adhesive disposed along the first edge of the plate.

### BACKGROUND

The present disclosure relates to photonic integrated circuit (PIC) packages, and more specifically, structures and methods for aligning and securing optical fiber(s) to PIC dies using various adhesives.

Current photonic packages include precision aligned optical fibers on the surface or at the edge of a PIC die to transmit light into and from the optical devices therein such as waveguides and grating couplers. This optical alignment is performed actively, often by providing a light source and measuring maximum optical power in a fiber with precision motion equipment, often with positional tolerances <0.1 um. Thereafter an adhesive is used to permanently hold the fiber(s) in place which requires complex packaging integration schemes. Passively attached and optically coupled fibers provide numerous advantages reducing the integration and process complexity by eliminating the need to create a sensible optical signal in each fiber during alignment, retention and adhesive curing. In particular, optical fibers or optical fiber arrays are optically coupled to the PIC die and waveguides formed or positioned on the PIC die based on initial vision system registration with subsequent mechanical feature alignment of the optical light paths. Conventionally, lithographically defined grooves formed in a surface of the PIC die provide an alignment and retention feature to align an optical fiber to couple light from an end surface of the optical fiber to an exposed end of an optical waveguide in the PIC die. In this process, optical fibers are positioned by a pick-and-place tool into respective grooves in the surface of the PIC die. Grooves enable two linear contact regions for each optical fiber to align the optical fiber core to the waveguide in the PIC die. The two linear contact regions ensure optical alignment when the optical fiber is fully seated on the groove sidewalls, with the core of an optical fiber end aligned with the waveguide. Once in position, the optical fibers are secured in place using an adhesive.

One challenge in achieving high alignment accuracy is applying a uniform force along the optical fiber surfaces along the sidewall linear contact areas to ensure the optical fiber contacts the groove's sidewalls and/or prevent optical fibers from lifting up at the coupling end interface, i.e., to maintain position and pitch alignment within the groove. To address this situation, glass lids have been used to force the optical fibers into the groove fiber optic receptacles. In this arrangement, the glass lids are placed over the optical fiber(s) and pressed down to force the optical fiber(s) into place. More specifically, the pick-and-place tool tip is used to position and then apply a downward force to the glass lids. This situation is not ideal because the pick-and-place tool tips are typically not designed to apply force during adhesive cure, facilitate precision adhesive dispense and the process is not readily repeatable.

Other conventional processes may utilize distinct adhesives for securing the optical fibers within the grooves formed on the PIC die. However, accurately flowing the adhesives over the optical fibers can be difficult and/or time consuming For example, where the rheology of the adhesive used to secure the optical fibers into the grooves is difficult to predict and/or control, securing the optical fibers to the PIC die may result in undesirable overflow of the adhesive. Where the (non-optical) adhesive flows adjacent and/or is disposed over the waveguides of the PIC die, the photonic package may become inoperable. Furthermore, and dependent on the rheology of the adhesive, the combination of the flowing adhesive and the force applied by the glass lid may actually push or force the optical fiber from the groove, resulting in misalignment between the optical fiber and the corresponding waveguide. To ensure desired alignment and optical coupling, conventional processes must be slowed down by additional curing time and/or individual optical fiber installation. This in turn results in lost income because of longer manufacturing times.

### SUMMARY

Accordingly, it would be beneficial to provide methods and structures for aligning optical fibers to PIC dies with improved accuracy in alignment, as well as reduced manufacturing time.

A first aspect of the disclosure includes a photonic integrated circuit (PIC) package. The PIC package includes a PIC die including: at least one waveguide positioned on the PIC die, and at least one groove formed in a surface of the PIC die, the at least one groove corresponding to and positioned directly adjacent the at least one waveguide; at least one optical fiber operatively coupled to the at least one waveguide of the PIC die, the at least one optical fiber positioned in the groove of the PIC die and including an end positioned adjacent the at least one waveguide; a plate positioned over a section of the at least one optical fiber, the plate including: a first edge positioned adjacent the at least one waveguide of the PIC die, and a second edge positioned opposite the first edge; a first adhesive disposed along the second edge of the plate, the first adhesive disposed over a first portion of the at least one optical fiber; and a second adhesive disposed along the first edge of the plate, the first adhesive disposed over a second portion of the at least one optical fiber including the end, and a portion of the at least one waveguide.

A second aspect of the disclosure includes a method, including positioning an optical fiber within a groove formed in a surface of a photonic integrated circuit (PIC) die, the groove corresponding to and positioned directly adjacent a waveguide positioned on the PIC die; positioning a plate over a section of the optical fiber, the plate including: a first edge positioned adjacent the waveguide, and a second edge positioned opposite the first edge; dispensing a first adhesive along the second edge of the plate to be disposed over a first portion of the optical fiber; dispensing a second adhesive along the first edge of the plate to be disposed over a second portion of the optical fiber and a portion of the waveguide; and curing at least one of the dispensed first adhesive or the dispensed second adhesive.

As will be appreciated, while one optical fiber is discussed in the various aspects of the disclosure, the PIC packages may include a plurality of optical fibers and corresponding waveguides formed on the PIC dies.

The illustrative aspects of the present disclosure are designed to solve the problems herein described and/or other problems not discussed.

### BRIEF DESCRIPTION OF THE DRAWINGS

The embodiments of this disclosure will be described in detail, with reference to the following figures, wherein like designations denote like elements, and wherein:

FIG. 1 shows an isometric view of a photonic integrated circuit (PIC) package including an optical fiber, according to embodiments of the disclosure.

FIG. 2 shows a top view of the PIC package of FIG. 1, according to embodiments of the disclosure.

FIG. 3 shows a front cross-sectional view of the PIC package taken along line 3-3 in FIG. 2, according to embodiments of the disclosure.

FIG. 4 shows a front cross-sectional view of the PIC package taken along line 4-4 in FIG. 2, according to embodiments of the disclosure.

FIG. 5 shows a front cross-sectional view of the PIC package taken along line 5-5 in FIG. 2, according to embodiments of the disclosure.

FIG. 6 shows a top view of a PIC package including an optical fiber, according to additional embodiments of the disclosure.

FIG. 7 shows a top view of a PIC package including a plurality of optical fibers, according to further embodiments of the disclosure.

FIG. 8 shows a flow chart of a process of securing an optical fiber within a PIC package, according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

Reference will now be made in greater detail to various embodiments of the subject matter of the present application, some embodiments of which are illustrated in the accompanying drawings. The same reference numerals will be used throughout the drawings to refer to the same or similar parts.

As discussed herein, the present disclosure relates to photonic integrated circuit (PIC) packages, and more specifically, structures and methods for aligning and securing optical fiber(s) to PIC dies using various adhesives.

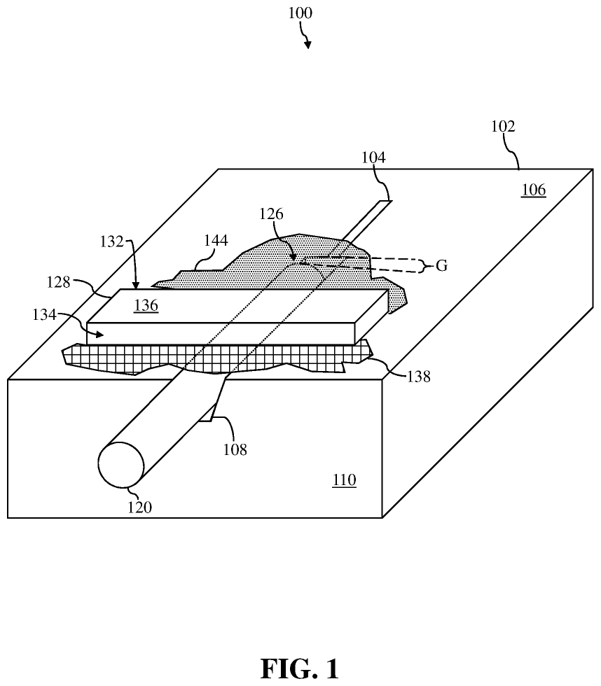

These and other embodiments are discussed below with reference to FIGS. 1-8. However, those skilled in the art will readily appreciate that the detailed description given herein with respect to these Figures is for explanatory purposes only and should not be construed as limiting.

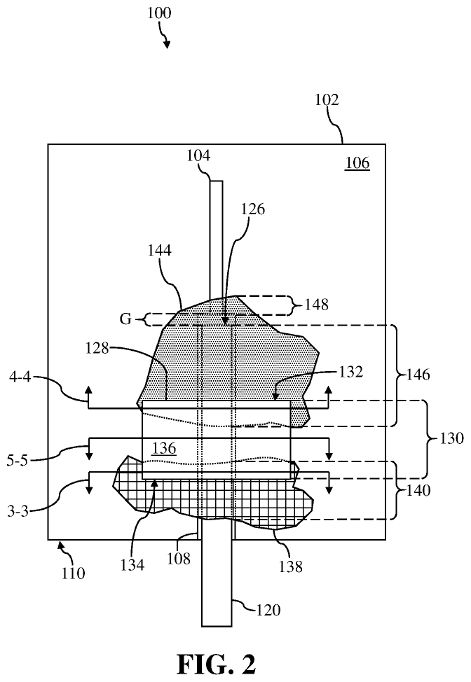

FIGS. 1 and 2 show various views of a photonic integrated circuit (PIC) package 100. More specifically, FIG. 1 shows an isometric view of PIC package 100 and FIG. 2 shows a top view of PIC package 100. As discussed herein, PIC package 100, and the various components formed thereon may improve on the quality of the manufactured part, as well as improve or reduce the manufacturing time to form PIC package 100.

As shown in FIGS. 1 and 2, PIC package 100 may include a PIC die 102. PIC die 102 may include any now known or later developed semiconductor photonic integrated circuit. Additionally, PIC die 102 (also known as integrated optical circuits) may define a portion of a photonics chip, and/or can be any device that includes electro-optical circuitry that integrates photonic functions for optical information signals received thereby via, e.g., optical fibers, as discussed herein. Such functions oftentimes include converting the optical information signals to electrical signals or vice versa. As discussed herein, the electro-optical circuitry may include an optical waveguide(s) operably coupled to optical fibers, each positioned on and/or within PIC die 102.

In a non-limiting example, PIC die 102 may include a semiconductor material such as silicon, e.g., single crystal Si or polycrystalline Si, or a silicon-containing material. Silicon-containing materials include, but are not limited to, single crystal silicon germanium (SiGe), polycrystalline silicon germanium, silicon doped with carbon (Si:C), amorphous Si, as well as combinations and multi-layers thereof. As used herein, the term “single crystal” denotes a crystalline solid, in which the crystal lattice of the entire solid is substantially continuous and substantially unbroken to the edges of the solid with substantially no grain boundaries. PIC die 102 may include (100)-oriented silicon or (111)-oriented silicon, for example. In other non-limiting examples PIC die 102 may also be formed from glass or similar amorphous (e.g., not crystalline) material.

PIC die 102 is not limited to silicon-containing materials, however, as PIC die 102 may include other semiconductor materials, including Ge and compound semiconductors, including III-V compound semiconductors such as GaAs, InAs, GaN, GaP, InSb, ZnSe, and ZnS, and II-VI compound semiconductors such as CdSe, CdS, CdTe, ZnSe, ZnS and ZnTe.

PIC die 102 may be a bulk substrate or a composite substrate such as a semiconductor-on-insulator (SOI) substrate that includes, from bottom to top, a handle portion, an isolation layer (e.g., buried oxide layer), and a semiconductor material layer (e.g., silicon).

In the non-limiting example shown in FIGS. 1 and 2, PIC die 102 may include at least one electro-optical circuitry or waveguide 104 (hereafter, “waveguide 104”) positioned thereon. That is, waveguide 104 of PIC package 100 may be positioned and/or formed on a surface 106 of PIC die 102. Waveguide 104 may be any suitable device or system that may integrate photonic functions for optical information signals received thereby, and/or convert and transmit optical information signals, e.g., via optical fiber(s). In a non-limiting example, waveguide 104 may be configured as a suspended waveguide that may be positioned in and/or above a void (not shown) formed in PIC die 102. However waveguide 104 may also include, depending on application, other components such as but not limited to: a Bragg reflector, an arrayed waveguide grating or other wave guide, transistor based electronics including detectors and modulators, amplifiers, and/or an externally modulated laser diode with an electro-absorption modulator. As such waveguide 104 may be formed as any suitable device and/or component that may a conductive and confinement medium for electromagnetic radiation/light. It is understood that waveguide 104 positioned on surface 106 of PIC die 102 may include structures to guide light/signals from optical fiber coupled thereto, individually.

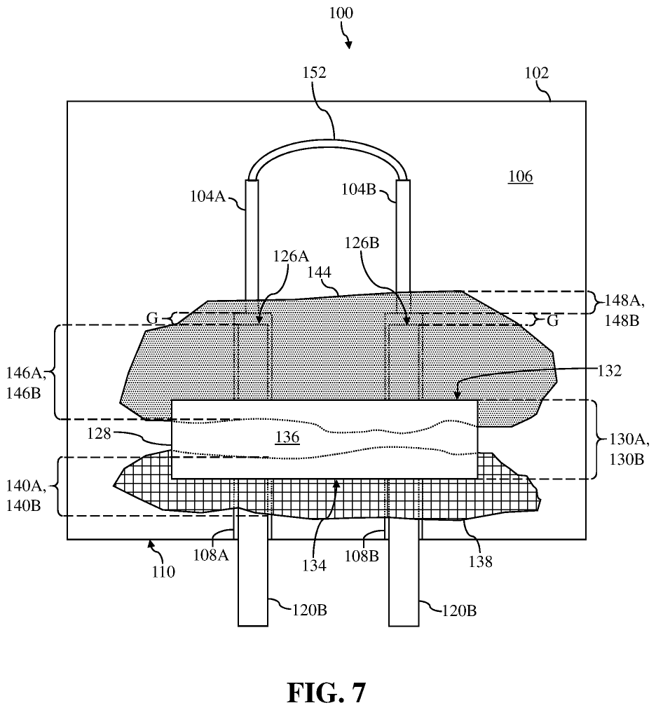

Although a single waveguide 104 is shown in the non-limiting example, it is understood that PIC package 100 may include more waveguides (see, FIG. 7). As such, the number of waveguides included in PIC package 100 are illustrative, and may be dependent at least in part on the function, purpose, and/or desired operation for PIC package 100.

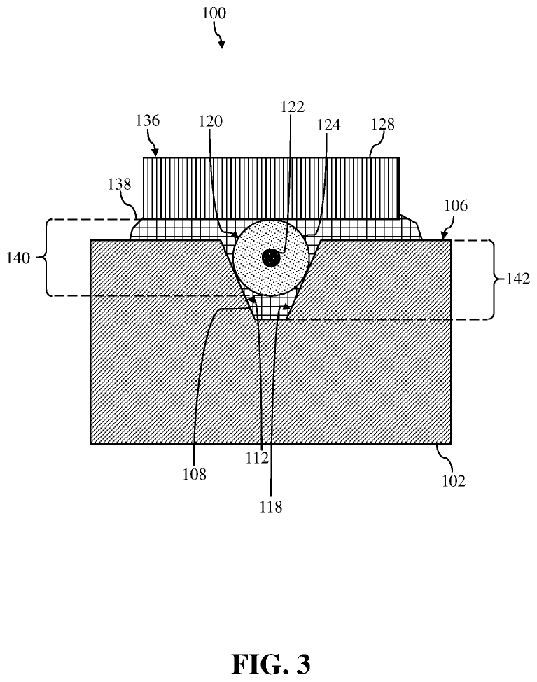

PIC die 102 of PIC package 100 may also include at least one groove 108. Groove 108 may be formed in surface 106 of PIC die 102. More specifically, groove 108 may be formed in surface 106 of PIC die 102 and may be positioned and/or formed directly adjacent waveguide 104 of PIC die 102. Additionally, and as shown in FIGS. 1 and 2, groove 108 formed in and/or positioned on surface 106 of PIC die 102 may extend from directly adjacent waveguide 104 to a side 110 of PIC die 102. In non-limiting examples, surface 106 of PIC die 102 may be machined, etched (e.g., plasma, chemical), mechanical grinded, molded, and/or any combination of these processes, to form groove 108 therein. As discussed herein, groove 108 of PIC die 102 may receive an optical fiber therein and may provide alignment and/or retention of the optical fiber to optical couple light from the optical fiber to waveguide 104 of PIC die 102. Briefly turning to FIG. 3, for example and as discussed herein, groove 108 may include two sloped or angled sidewalls 112, 118 that provide two points of contact for an optical fiber positioned therein to align the optical fiber with waveguide 104 and/or retention of the optical fiber therein.

Groove 108 of PIC die 102 may correspond to waveguide 104. That is, in the non-limiting examples discussed herein for every waveguide 104 formed in PIC die 102, PIC die 102 may include a corresponding groove 108 that may be formed and/or positioned directly adjacent waveguide 104. As such, although a single groove is shown in the non-limiting example of FIGS. 1 and 2, it is understood that PIC package 100 may include more grooves (see, FIG. 7). As such, the number of grooves 108 included in PIC package 100 are illustrative, and may be dependent at least in part on the function, purpose, and/or desired operation for PIC package 100 and/or the number of waveguides 104 included within PIC die 102. Although discussed herein as including angled sidewalls 112, 118 of groove 108 to aid in self alignment of optical fibers, groove 108 may include orthogonal or linear sidewalls for grooves 108. In this non-limiting example, the orthogonal sidewalls may be sized to form a tight fit or clearance to the optical fibers and/or precise control of the depth of groove 108 to define and/or ensure alignment between the optical fiber and waveguide 104, as discussed herein. Additionally, and as discussed herein, grooves 108 may also be used in non-electrical optical devices—such as a passive optical network that is created exclusively in glass—not an electrical device.

In the non-limiting example shown in FIGS. 1 and 2, PIC package 100 may also include at least one optical fiber 120. Optical fiber 120 may be positioned within groove 108 of PIC die 102. More specifically, optical fiber 120 may be positioned within groove 108, and may extend from adjacent waveguide 104 of PIC die 102 to beyond side 110 of PIC die 102. As shown in FIG. 3, Optical fiber 120 may be positioned within groove 108, and may contact and/or may meet angled sidewalls 112, 118 of groove 108, to ensure alignment with waveguide 104, as discussed herein. Optical fiber 120 and/or groove 108 may be sized and/or may include a shape/configuration that may ensure the meeting/contacting between optical fiber 120 and groove 108, and/or alignment of optical fiber 120 with waveguide 104. In the non-limiting example shown in FIG. 3, optical fiber 120 and/or groove 108 may also be sized such that at least a portion of optical fiber 120 extends above surface 106 of PIC die 102. In other non-limiting examples (not shown), optical fiber 120 and/or groove 108 may be sized such that the entirety of optical fiber 120 is positioned below surface 106 of PIC die 102, or a top portion of optical fiber 120 is aligned with and/or co-planar with surface 106 of PIC die 102.

Optical fiber 120 may be formed as any suitable optical element or structure that is configured to transmit and/or receive optical information signals to/from waveguide 104. In the non-limiting example shown in FIG. 3, optical fiber 120 may include a core 122 and a cladding layer 124 surrounding core 122. Cladding layer 124 of optical fiber 120 may directly contact and/or meet sidewalls 112, 118 of groove 108 formed in PIC die 102. In a non-limiting example, and as discussed herein, core 122 may be formed from a silicon, silica, or silica doped material and may be aligned with and operatively coupled to waveguide 104 for sending and/or receiving optical information signals. Although only one core is shown, optical fiber may include multicore core fibers for optical coupling between optical fiber 120 and PIC die 102/waveguide 104. In other non-limiting examples (not shown) optical fiber 120 may also include an insulating jacket surrounding cladding layer 124. In other non-limiting examples, optical fibers 120 may be formed as fluoride fibers, chalcogenide fibers, or plastic fibers.

Returning to FIGS. 1 and 2, Optical fiber 120 may also include an end 126 positioned adjacent waveguide 104. That is, when optical fiber 120 is positioned within groove 108 of PIC die 102, end 126 of optical fiber 120 may be positioned adjacent waveguide 104. Additionally, and as shown in the non-limiting example, end 126 of optical fiber 120 positioned within groove 108 may be separated from and/or positioned a distance away from waveguide 104 formed directly adjacent groove 108. That is, a gap (G) may separate end 126 of optical fiber 120 and waveguide 104. In a non-limiting example, the gap (G) may be approximately three (3) microns to approximately 15 microns.

As discussed herein, position (and securing) optical fiber 120 within groove 108 may operatively couple optical fiber 120 with waveguide 104. That is, groove 108 may be formed in surface 106 of PIC die 102 and/or may be sized to receive and align optical fiber 120 with waveguide 104. Once positioned within and aligned with waveguide 104, optical fiber 120 may also be operatively coupled and/or in optical communication with waveguide 104. In the non-limiting example, core 122 (see, FIG. 3) may be operatively coupled with waveguide 104 to transmit and/or receive optical information signals to/from waveguide 104 during operation of PIC package 100.

Similar to groove 108 of PIC die 102, optical fiber 120 may correspond to waveguide 104. That is, in the non-limiting examples discussed herein for every waveguide 104 formed in PIC die 102, an optical fiber 120 may be aligned with and operatively coupled to waveguide 104. As such, although a single optical fiber is shown in the non-limiting example of FIGS. 1 and 2, it is understood that PIC package 100 may include more optical fibers (see, FIG. 7). As such, the number of optical fibers 120 included in PIC package 100 are illustrative, and may be dependent at least in part on the function, purpose, and/or desired operation for PIC package 100 and/or the number of waveguides 104 included within PIC die 102.

PIC package 100 may also include a plate 128. As shown in FIG. 2, plate 128 may be positioned over a section 130 of optical fiber 120. Plate 128 may include and/or may be formed as an ultraviolet (UV) transparent glass plate. In other non-limiting examples, plate 128 may be formed from any UV transparent material to aid in the curing of adhesives dispensed and/or disposed over PIC die 102 as well as provide a force to optical fiber 120 to position optical fiber 120 within groove 108, as discussed herein. Additionally, plate 128 may be formed from any suitable material that may have a total thickness variation (TTV) that is approximately equal to or less than 0.5 microns (μm). In the non-limiting example, plate 128 may include a first edge 132, a second edge 134, and a top surface 136. First edge 132 of plate 128 may be positioned over PIC die 102, adjacent waveguide 104 of PIC die 102. That is, first edge 132 of plate 128 may be positioned adjacent, approximate, and/or near waveguide 104 and end 126 of optical fiber 120. As a result of being positioned adjacent to, and not over, end 126 of optical fiber 120, end 126 of optical fiber (as well as waveguide 104) may be uncovered by plate 128 and/or may be exposed on PIC die 102 of PIC package 100 in the non-limiting example. Second edge 134 of plate 128 may be positioned opposite first edge 132. As shown in FIGS. 1 and 2, second edge 134 may also be positioned over PIC die 102 and, may be adjacent to and/or inward from side 110 of PIC die 102. As such, and in the non-limiting example, section 130 of optical fiber 120 positioned under and/or covered by plate 128 may not include first end 126 of optical fiber 120 or a part of optical fiber 120 that is positioned directly adjacent to and/or extends over side 110 of PIC die 102. Top surface 136 of plate 128 may extend between first edge 132 and second edge 134.

As discussed herein, plate 128 may be used to position and/or force optical fiber 120 into groove 108 in order to form PIC package 100. That is, plate 128 may apply a force to optical fibers 120 to position optical fiber 120 within groove 108, to ensure optical fiber 120 contacts or meets sidewalls 112, 118 of groove 108, and in turn is aligned with waveguide 104, as discussed herein. Additionally, plate 128 also aids in the application and retention of adhesives to PIC package 100, as discussed herein. Plate 128 may be sized and/or may include dimensions (e.g., thickness, width, length) that may ensure the desired section 130 of optical fiber 120 is covered when forming PIC package 100. As discussed herein with respect to FIG. 7, where PIC package 100 includes a plurality of optical fibers 120, plate 128 may be elongated and/or include larger dimensions to ensure each of the plurality of optical fibers 120 are positioned and/or forced into corresponding grooves 108 formed in PIC die 102.

In the non-limiting example shown in FIGS. 1 and 2, PIC package 100 may also include a first adhesive 138. First adhesive 138 may be disposed along second edge 134 of plate 128. That is, and as discussed herein, first adhesive 138 may be disposed over PIC die 102, linearly along and/or across second edge 134 of plate 128. In addition to being disposed along second edge 134, first adhesive 138 may flow, be dispensed, be disposed, and/or may be positioned over a first portion 140 of optical fiber 120 (see, FIG. 2). Turning to FIG. 3, and with continued reference to FIGS. 1 and 2, first adhesive 138 is disposed over first portion 140 of optical fiber 120 and/or disposed within a first portion 142 of groove 108 receiving first portion 140 of optical fiber 120. In the non-limiting example, first portion 140 of optical fiber 120 and/or first portion 142 of groove 108 may include areas which are covered by plate 128 and distinct areas which are uncovered and/or exposed, prior to the dispensing of first adhesive 138. At least some (e.g., uncovered area) of first portion 140 of optical fiber 120 and/or first portion 142 of groove 108 may be positioned directly adjacent side 110 of PIC die 102, while the remaining first portion 140 of optical fiber 120 and/or first portion 142 of groove 108 may be covered by plate 128. As a result, and as shown in the cross-sectional view of FIG. 3, first adhesive 138 may be disposed and/or positioned between plate 128 and surface 106 of PIC die 102. Additionally, and as shown in the non-limiting example of FIG. 3, first adhesive 138 may flow between and/or underneath optical fiber 120 to substantially cover sidewalls 112, 118 and/or fill groove 108 formed in PIC die 102.

The rheology properties of first adhesive 138 may ensure that first adhesive 138 may flow, be disposed over, and/or dispensed on first portion 140 of optical fiber 120 and/or disposed within a first portion 142 of groove 108 receiving first portion 140 of optical fiber 120. That is, and as discussed herein, first adhesive 138 may be formed from any suitable adhesive material that may allow first adhesive 138 to readily flow between plate 128 and surface 106 of PIC die 102, as well as flow over first portion 140 of optical fiber 120 and/or be disposed within a first portion 142 of groove 108 receiving first portion 140 of optical fiber 120. In a non-limiting example, first adhesive 138 may be formed from any suitable ultraviolet (UV) curable adhesive material, for example various polymers or curable epoxy, acrylate or combinations thereof. As discussed herein, first adhesive 138 may aid in securing optical fiber 120 within groove 108 of PIC die 102. Furthermore, by forming first adhesive 138 from a curable adhesive material, first adhesive 138 may be quickly cured to arrest and/or stop the flow of first adhesive 138 after dispensing along second edge 134 of plate 128. This in turn may prevent first adhesive 138 from flowing or being disposed over and/or contacting end 126 of optical fiber 120 and/or waveguide 104 of PIC package 100. Additionally, or alternative, the UV curable adhesive material forming first adhesive 138 may also be thermally curable using any suitable process.

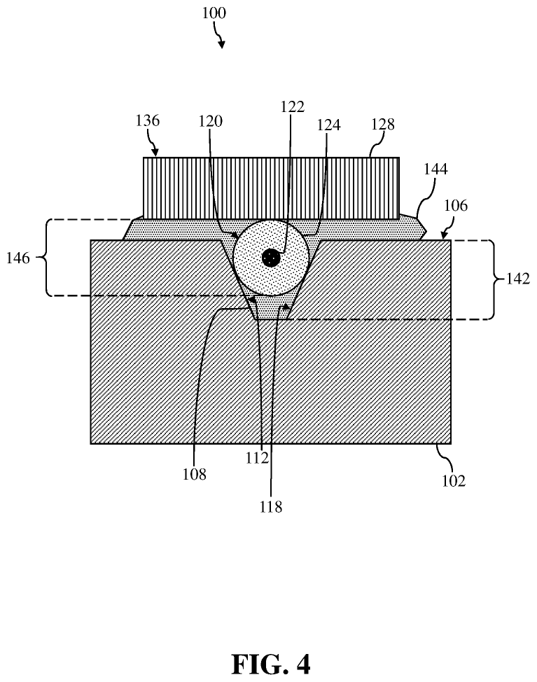

PIC package 100 may include a second optically functional adhesive 144. Second adhesive 144 may be disposed along first edge 132 of plate 128. That is, and as discussed herein, second adhesive 144 may be disposed over PIC die 102, linearly along and/or across first edge 132 of plate 128. In addition to being disposed along first edge 132, second adhesive 144 may flow, be dispensed, be disposed, and/or may be positioned over a second portion 146 of optical fiber 120, including end 126, as well as a portion 148 of waveguide 104 (see, FIG. 2). Turning to FIG. 4, and with continued reference to FIGS. 1 and 2, second adhesive 144 is disposed over second portion 146 of optical fiber 120 and/or disposed within a second portion 150 of groove 108 receiving second portion 146 of optical fiber 120. In the non-limiting example, second portion 146 of optical fiber 120 and/or second portion 150 of groove 108 may include areas which are covered by plate 128 and distinct areas which are uncovered and/or exposed, prior to the dispensing of second adhesive 144. At least some (e.g., uncovered area) of second portion 146 of optical fiber 120 and/or second portion 150 of groove 108 may be positioned directly adjacent waveguide 104 of PIC die 102, while the remaining second portion 146 of optical fiber 120 and/or second portion 150 of groove 108 may be covered by plate 128. In this non-limiting example, second adhesive 144 may be disposed over and/or may cover end 126 of optical fiber 120 included in second portion 146. As a result, and as shown in the cross-sectional view of FIG. 4, second adhesive 144, like first adhesive 138, may be disposed and/or positioned between plate 128 and surface 106 of PIC die 102. Additionally, and as shown in the non-limiting example of FIG. 4, second adhesive 144 may flow between and/or underneath optical fiber 120 to substantially cover sidewalls 112, 118 and/or fill groove 108 formed in PIC die 102.

Similar to first adhesive 138, the rheology properties of second adhesive 144 may ensure that second adhesive 144 may flow, be disposed over, and/or dispensed on second portion 146 of optical fiber 120 and/or disposed within second portion 150 of groove 108 receiving second portion 146 of optical fiber 120. That is, and as discussed herein, second adhesive 144 may be formed from any suitable adhesive material that may allow second adhesive 144 to readily flow between plate 128 and surface 106 of PIC die 102, as well as flow over second portion 146 of optical fiber 120 and/or be disposed within second portion 150 of groove 108 receiving second portion 146 of optical fiber 120. In a non-limiting example, second adhesive 144 may be formed from any suitable optical adhesive material, for example various polymer resins or silicone. As discussed herein, second adhesive 144 may aid in securing optical fiber 120 within groove 108 of PIC die 102. Furthermore, second adhesive 144 formed as an optical adhesive may be configured and/or may include properties/material characteristics that may optically couple optical fiber 120 to waveguide 104 of PIC die 102. In a non-limiting example, the optical adhesive forming second adhesive 144 may include refractive index of about 1.2 to 1.6, and including ranges between any of the foregoing values, a viscosity (at 23° C.) of 200 to 600 centipoise (cP), a glass transition temperature (T_{g}) of 0° C. to 140° C., an optical transmittance (at 1.3 microns) of at least 85%, e.g., 85, 88, 90, 92 or 94%, including ranges between any of the foregoing values, and a bond strength of 100 to 200 kgf/cm². These material characteristics may ensure second adhesive 144 optically couples optical fiber 120, and more specifically core 122, with waveguide 104. Additionally, the optical adhesive forming second adhesive 144 may be UV curable and/or thermally curable using any suitable process.

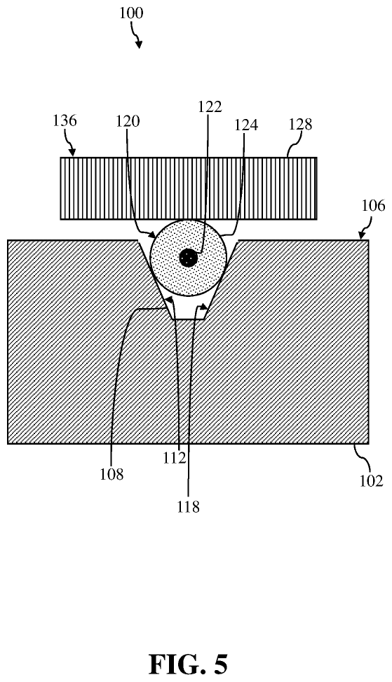

Turning to FIG. 5, and with continued reference to FIG. 2, a cross-sectional front view of PIC package 100 is shown. The cross-sectional view is taken along line 5-5 in FIG. 5. In the non-limiting example shown in FIG. 5, first adhesive 138 and second adhesive 144 dispensed on PIC die 102 may be separated from one another. That is, in the non-limiting example shown in FIGS. 2 and 5 the portions of first adhesive 138 and second adhesive 144 that flow and/or are disposed between plate 128 and surface 106 of PIC die 102 are separate from one another and/or do not touch. This may be a result of controlling volume of each of the first adhesive 138 and/or second adhesive 144 dispensed or disposed on PIC die 102. In another non-limiting example, and as discussed herein, second adhesive 144 may be separated from first adhesive 138 as a result of curing first adhesive 138 after dispensing and/or deposition. That is, first adhesive 138 may be cured to arrest and/or stop the flow of first adhesive 138 after dispensing along second edge 134 of plate 128, and/or to prevent first adhesive 138 from flowing over end 126 of optical fiber 120 and/or waveguide 104. In this example, the volume of second adhesive 144 and/or thermally curing second adhesive 144 after the dispensing process may also prevent second adhesive 144 from contacting with first adhesive 138.

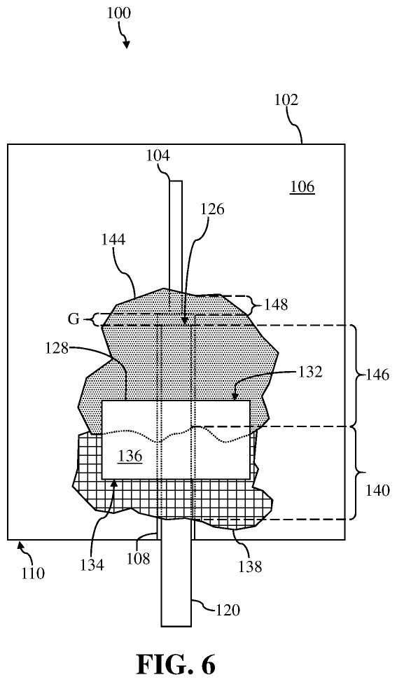

FIG. 6 shows a top view of another non-limiting example of PIC package 100 including optical fiber 120, plate 128, first adhesive 138, and second adhesive 144. It is understood that similarly numbered and/or named components may function in a substantially similar fashion. Redundant explanation of these components has been omitted for clarity.

Distinct from the non-limiting example discussed herein with respect to FIGS. 1-5, the example of FIG. 6 depicts first adhesive 138 and second adhesive 144 contacting, touching, and/or mixing on PIC die 102. That is, in the non-limiting example, first adhesive 138 and second adhesive 144 may not be separated and/or spaced apart on PIC die 102, but rather, may contact one another after being disposed (and cured) on surface 106 of PIC die 102. In the non-limiting example, both first adhesive 138 and second adhesive 144 may be dispensed onto PIC die 102 as discussed herein, prior to either adhesive being cured. Once dispensed, disposed, and/or flowed to over the desired portions of optical fiber 120 and/or waveguide 104, first adhesive 138 and second adhesive 144 may be (thermally) cured together. First adhesive 138 and second adhesive 144 do not have to be dispensed separately from one another, nor do first adhesive 138 and second adhesive 144 have to be dispensed than cured prior to dispensing the distinct adhesive. Rather, to aid in the alignment/securing of optical fiber 120 within groove 108 and optically coupling optical fiber 120 with waveguide 104, first adhesive 138 must cover or be disposed over first portion 140 of optical fiber 120, while second adhesive 144 cover or be disposed over second portion 146 of optical fiber 120 including end 126, as well as portion 148 of waveguide 104.

FIG. 7 shows a top view of another non-limiting example of PIC package 100 including a plurality of features. It is understood that similarly numbered and/or named components may function in a substantially similar fashion. Redundant explanation of these components has been omitted for clarity.

In the non-limiting example shown in FIG. 7, PIC package 100 may include a plurality of waveguides 104A, 104B position on PIC die 102. The plurality of waveguides 104A, 104B may be positioned adjacent one another and/or may be formed substantially parallel to one another in surface 106 of PIC die 102. Additionally as shown in FIG. 7, PIC package 100 may include a plurality of grooves 108A, 108B formed in surface 106 of PIC die 102. Each groove 108A, 108B may correspond to and may be positioned direct adjacent one of the plurality of waveguides 104A, 104B. For example, first groove 108A may correspond to, may be positioned directly adjacent, and/or may be aligned with first waveguide 104A of PIC die 102. Similarly, second groove 108B may correspond to, may be positioned directly adjacent, and/or may be aligned with second waveguide 104B of PIC die 102. Like waveguides 104A, 104B, grooves 108A, 108B may be formed (e.g., machined, etched) and/or positioned on surface 106 of PIC die 102 adjacent one another and/or in parallel to one another.

Also shown in FIG. 7, PIC package 100 may include a plurality of optical fibers 120A, 120B. Each of the plurality of optical fibers 120A, 120B may be operatively coupled to one of the corresponding waveguides 104A, 104B of PIC die 102, and/or may be positioned in one of the corresponding plurality of grooves 108. For example, first optical fiber 120A may be operatively and/or optically coupled to first wave guide 104A, and may be positioned within first groove 108A. Additionally, second optical fiber 120B may be operatively and/or optically coupled to second wave guide 104B, and may be positioned within second groove 108B. In the non-limiting example, each of the plurality of optical fibers 120A, 120B may include ends 126A, 126B positioned within grooves 108A, 108B and separated from and/or positioned a distance away (e.g., gap (G)) from corresponding waveguides 104A, 104B.

In the non-limiting example, a single plate 128 may be positioned over both optical fibers 120A, 120B. More specifically, and as shown in FIG. 7, plate 128 may extend or be positioned over respective sections 130A, 130B of the plurality of optical fibers 120A, 120B. Section 130A, 130B of optical fibers 120A, 120B positioned under and/or covered by plate 128 may not include respective first ends 126A, 126B of optical fibers 120A, 120B or a part of optical fibers 120A, 120B that are positioned directly adjacent to and/or extend over side 110 of PIC die 102.

As shown in FIG. 7, First adhesive 138 may be disposed along second edge 134 of plate 128. That is, and as discussed herein, first adhesive 138 may be disposed over PIC die 102, linearly along and/or across second edge 134 of plate 128. In addition to being disposed along second edge 134, first adhesive 138 may flow, be dispensed, be disposed, and/or may be positioned over distinct first portions 140A, 140B of optical fibers 120A, 120B, as well as a portion of PIC die 102 formed between first portions 140A, 140B. In the non-limiting example, first portions 140A, 140B of optical fibers 120A, 120B may include areas which are covered by plate 128 and distinct areas which are uncovered and/or exposed, prior to the dispensing of first adhesive 138. At least some (e.g., uncovered area) of first portions 140A, 140B of optical fibers 120A, 120B may be positioned directly adjacent side 110 of PIC die 102, while the remaining first portions 140A, 140B of optical fibers 120A, 120B may be covered by plate 128. Additionally, first adhesive 138 may be disposed and/or positioned between plate 128 and surface 106 of PIC die 102, as well as between and/or adjacent to optical fibers 120A, 120B.

Additionally, second adhesive 144 may be disposed along first edge 132 of plate 128. That is, and as discussed herein, second adhesive 144 may be disposed over PIC die 102, linearly along and/or across first edge 132 of plate 128. In addition to being disposed along first edge 132, second adhesive 144 may flow, be dispensed, be disposed, and/or may be positioned over second portions 146A, 146B of optical fibers 120A, 120B, including ends 126A, 126B, as well as portions 148A, 148B of respective waveguides 104A, 140B. In the non-limiting example, second portions 146A, 146B of optical fibers 120A, 120B may include areas which are covered by plate 128 and distinct areas which are uncovered and/or exposed, prior to the dispensing of second adhesive 144. At least some (e.g., uncovered area) of second portions 146A, 146B of optical fibers 120A, 120B may be positioned directly adjacent waveguides 104A, 104B of PIC die 102, while the remaining second portions 146A, 146B of optical fibers 120A, 120B may be covered by plate 128. In this non-limiting example, second adhesive 144 may be disposed over and/or may cover ends 126A, 126B of optical fibers 120A, 120B included in second portions 146A, 146B. As a result, second adhesive 144, like first adhesive 138, may be disposed and/or positioned between plate 128 and surface 106 of PIC die 102, as well as between and/or adjacent to optical fibers 120A, 120B.

Also shown in the non-limiting example PIC package 100 may include an optical loopback 152. Optical loopback 152 may be optically and/or operatively coupled to at least two of the plurality of waveguides 104A, 104B included on PIC die 102. As shown in FIG. 7, optical loopback 152 may be positioned opposite optical fibers 120A, 120B, and may be formed and/or positioned on surface 106 of PIC die 102. In the non-limiting example where PIC package 100 includes optical loopback 152, waveguide 104A, 104B and optical fibers 120A, 120B may form one optical information signal in-line, and one optical information signal out-line. In this non-limiting example, optical loopback 152 may allow distinct waveguides 104A, 104B to transmit data and/or signals between one another.

Although two waveguides, grooves, and optical fibers are shown in FIG. 7, it is understood that the number of waveguides, grooves, and optical fibers for the PIC package is merely illustrative. As such, PIC package may include more than two waveguides, grooves, and optical fibers, where optical fibers are arranged as an array assembly. For example, the PIC package may include an array of 12 optical fibers that may all be secured, aligned, and/or optically coupled simultaneously using the process discussed herein.

Additionally during the installation process, when a first or single optical fiber is positioned within the PIC die, the entire die and/or package may move, rotate, and/or “rock” based on the force of positioning the optical fiber in the groove. To aid in the stabilization during installation and/or positioning of the optical fiber in the grooves formed in the PIC die, as discussed herein in detail, the PIC die may include auxiliary or “inactive” grooves and corresponding auxiliary or “inactive” fibers. The inactive grooves and inactive fibers may provide additional support for the single optical fiber, and/or may spread the force applied to the PIC die across multiple locations to avoid the movement of the die during installation. These inactive grooves and/or inactive fibers may not be configured to transmit and/or receive optical signals, and may be provided purely for mechanical support in embodiments that include a single, (active) optical fiber.

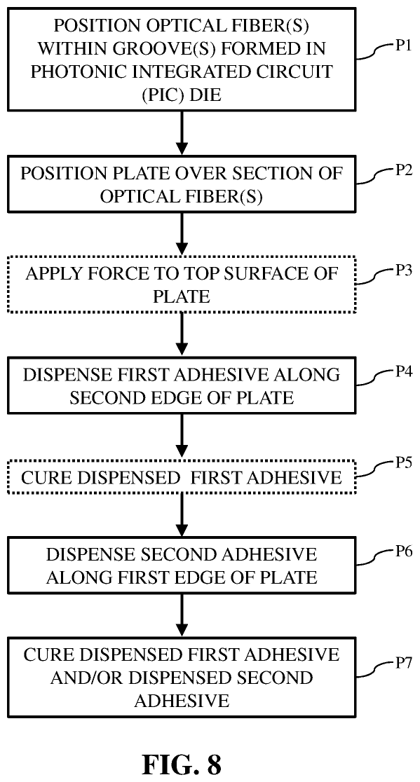

FIG. 8 depicts a flow chart illustrating a process for forming PIC packages as discussed herein. Specifically, FIG. 8 shows a non-limiting example process for aligning and securing optical fiber(s) to PIC dies using various adhesives.

In process P1 one or more optical fibers may be positioned within a groove formed in a PIC die of the PIC package. More specifically, optical fiber(s) may be positioned in a groove formed in a surface of the PIC die. The groove may correspond to and be positioned directly adjacent a corresponding waveguide positioned and/or formed on the surface of the PIC die. Positioning the optical fiber within the groove may also include positioning an end of the optical fiber within the groove directly adjacent the waveguide. In a non-limiting example, the end of the optical fiber may be separated from and/or may not directly contact the waveguide, but rather may be positioned such that a gap (G) exists between the end of the optical fiber and the waveguide.

In process P2, a plate may be positioned over a section of the optical fibers. The plate may include a first edge positioned adjacent, but separated from, the waveguide formed in the surface of the PIC die, and a second edge positioned opposite the first edge. The second send may be positioned adjacent and distanced from a side of the PIC die in which the optical fibers extend beyond. Positioning the plate in process P2 may also include positioning the first edge of the plate adjacent the end of the optical fiber, but not covering the end of the optical fiber. As a result, the end of the optical fibers may be exposed and/or remain uncovered by the plate during the formation process discussed herein.

In process P3 (shown in phantom as optional), a force may be applied to a top surface of the plate. More specifically, a force may be applied to a top, exposed surface of the plate that extends between the first edge and the second edge of the plate to press the optical fiber into the groove of the PIC die. The force applied to the plate may ensure that the optical fiber is positioned and/or aligned within the groove and temporarily secured to PIC die before being adhered, as discussed in detail below. In a non-limiting example, a force may be applied to the plate using a pin attached to a gimbal assembly for ensuring even distribution of the force. The pin may be a straight pin applying a downward force on the plate, or alternatively, may be an angled pin to minimize the space required by the pin-gimbal assembly to apply the force, and/or to reduce the blockage of an ultraviolet light during a curing process, as discussed herein.

In process P4 a first adhesive may be dispensed on the PIC die. More specifically, a first adhesive may be dispensed linearly along the second edge of the plate, adjacent the side of the PIC die. The dispensed first adhesive may be disposed and/or may cover a first portion of the optical fiber. Additionally, the dispensed first adhesive may be disposed, may cover, and/or may flow into a first portion of the groove that may receive the first portion of the optical fiber. Additionally, the dispensed first adhesive may be flowed between the plate and the surface of the PIC die, adjacent the first portion of the optical fiber. The first adhesive may be formed as a UV curable adhesive material.

In process P5 (shown in phantom as optional), the first adhesive may be cured. More specifically, after dispensing the first adhesive and allowing time for the first adhesive to flow over the first portion of the optical fiber, the first adhesive may be cured. The first adhesive may be cured using any suitable curing technique or process. For example, where the first adhesive is formed as a UV curable adhesive material, the PIC die include the first adhesive may be exposed to a UV light (e.g., 1-2 minutes) to cure the first adhesive. Curing the first adhesive may arrest and/or stop the flow of the first adhesive as it is disposed and/or covers portions of the PIC die. Curing the first adhesive may also ensure that the first adhesive does not flow over and/or cover the (exposed) end of the optical fiber and/or a portion of the waveguide. Curing the first adhesive may take place prior to dispensing the second adhesive in process P6. In response to performing process P5 and curing the first adhesive dispensed on the PIC die, the force applied to the plate may be removed and/or discontinued. That is, curing the first adhesive in process P5 may ensure that the optical fibers are secured within the grooves of the PIC die enough to continue performing processes for securing and/or aligning the optical fibers on the PIC package without the need of the applied force (e.g., process P3). As such, the pin applying the force may be removed, and additional processes may be performed on the PIC package.

In process P6 a second adhesive may be dispensed on the PIC die. More specifically, a second adhesive may be dispensed linearly along the first edge of the plate, adjacent the waveguide included in the PIC die. The dispensed second adhesive may be disposed and/or may cover a second portion of the optical fiber and a portion of the waveguide. The second portion of the optical fiber may include the end of the optical fiber positioned directly adjacent to, but separated from the waveguide. Additionally, the dispensed second adhesive may be disposed, may cover, and/or may flow into a second portion of the groove that may receive the second portion of the optical fiber. Additionally, the dispensed second adhesive may be flowed between the plate and the surface of the PIC die, adjacent the second portion of the optical fiber. In a non-limiting example, the second adhesive may be dispensed and/or may flow to be separate and/or distant from the (cured) first adhesive. In another non-limiting example, the second adhesive may be dispensed and/or may flow to contact the first adhesive and/or prevent the first adhesive from being disposed over and/or covering the end of the optical fiber and/or the waveguide. The second adhesive may be formed as an optical adhesive material that may be configured to optically couple the optical fiber and the waveguide for which the first adhesive is dispensed and/or disposed over.

In process P7 the adhesives are cured. More specifically, and dependent on whether the curing process of P5 is performed, at least one of the first adhesive or the second adhesive dispensed on the PIC die is cured. In non-limiting examples, the first adhesive and/or the second adhesive may be thermally cured using any suitable curing process and/or technique. Where process P5 is not performed, the first adhesive and the second adhesive may be (thermally) cured simultaneously to form the desired PIC package. Alternatively where process P5 is performed, and the first adhesive is cured, process P7 may include (thermally) curing the second adhesive dispensed and/or disposed on the identified portions of the PIC die.

The adhesives discussed herein may be dispensed using any suitable dispense system, such as a micro fluid dispense system marketed by Nordson (East Providence, R.I.). An example dispense system may include portable or bench-top dispense system that is operable to pressurize and deliver through a dispensing tip an effective amount of the adhesives to a desired location on the PIC package, e.g., the linearly along the first edge or the second edge of the plate.

It will be recognized that the teachings of the disclosure are also applicable for alternate applications in which optical fibers to polymer waveguides, laser dies in PIC die cavities, individual optical fibers and fiber ribbons in groove fiber optic receptacles, etc.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It will be understood that when an element such as a layer, region or substrate is referred to as being formed on, deposited on, or disposed “on” or “over” another element, it can be directly on the other element or intervening elements may also be present. In contrast, when an element is referred to as being “directly on” or “directly over” another element, no intervening elements are present.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

1. A photonic integrated circuit (PIC) package, comprising:
a PIC die including:
at least one waveguide positioned on the PIC die, and
at least one groove formed in a surface of the PIC die, the at least one groove corresponding to and positioned directly adjacent the at least one waveguide;
at least one optical fiber operatively coupled to the at least one waveguide of the PIC die, the at least one optical fiber positioned in the groove of the PIC die and including an end positioned adjacent the at least one waveguide, wherein the at least one optical fiber is positioned at at least one of: entirely within the groove below the surface of the PIC die; aligned with a top portion the at least one optical fiber aligned with the surface of the PIC die; or aligned with the at least one optical fiber being co-planar with the surface of the PIC die;
a plate positioned over a section of the at least one optical fiber, the plate including:
a first edge positioned adjacent the at least one waveguide of the PIC die, and
a second edge positioned opposite the first edge;
a first adhesive disposed along the second edge of the plate, the first adhesive disposed over a first portion of the at least one optical fiber; and
a second adhesive disposed along the first edge of the plate, the second adhesive disposed over a second portion of the at least one optical fiber including the end, and a portion of the at least one waveguide.

2. The PIC package of claim 1, wherein the first adhesive is an ultraviolet (UV) curable adhesive.

3. The PIC package of claim 1, wherein the second adhesive is an optical adhesive configured to optically couple the at least one optical fiber to the at least one waveguide of the PIC die.

4. The PIC package of claim 1, wherein the first edge of the plate is positioned adjacent to the end of the at least one optical fiber, and the end of the at least one optical fiber is uncovered by the plate.

5. The PIC package of claim 1, wherein the first adhesive is disposed within a first portion of the at least one groove receiving the first portion of the at least one optical fiber, and the second adhesive is disposed within a second portion of the at least one groove receiving the second portion of the at least one optical fiber.

6. The PIC package of claim 1, wherein the plate includes an ultraviolent (UV) transparent glass plate.

7. The PIC package of claim 1, wherein the second edge of the plate is positioned adjacent to and inward from a side of the PIC die, and wherein the at least one optical fiber extends beyond the side of the PIC die.

8. The PIC package of claim 1, wherein the first adhesive and the second adhesive are each disposed between the plate and the surface of the PIC die, and separated from one another.

9. The PIC package of claim 1, wherein the at least one waveguide includes a plurality of waveguides positioned on the PIC die, and wherein the at least one groove includes a plurality of grooves formed in the surface of the PIC die, each of the plurality of grooves corresponding to and positioned directly adjacent one of the plurality of waveguides.

10. The PIC package of claim 9, wherein the at least one optical fiber includes a plurality of optical fibers, each of the plurality of optical fibers operatively coupled to one of the plurality of waveguides of the PIC die and positioned in one of the plurality of grooves of the PIC die.

11. The PIC package of claim 10, wherein the plate is positioned over a section of each of the plurality of optical fibers.

12. The PIC package of claim 10, wherein the first adhesive is disposed over the first portion of each of the plurality of optical fibers, and the second adhesive is disposed over the second portion of each of the plurality of optical fibers, and the portion of each of the plurality of waveguides.

13. A method, comprising:
positioning an optical fiber within a groove formed in a surface of a photonic integrated circuit (PIC) die, the groove corresponding to and positioned directly adjacent a waveguide positioned on the PIC die, wherein positioning includes at least one of: positioning the optical fiber entirely within the groove below the surface of the PIC die; aligning a top portion of the optical fiber with the surface of the PIC die; or aligning the top portion of the optical fiber co-planar with the surface of the PIC die;
positioning a plate over a section of the optical fiber, the plate including:
a first edge positioned adjacent the waveguide, and
a second edge positioned opposite the first edge;
dispensing a first adhesive along the second edge of the plate to be disposed over a first portion of the optical fiber;
dispensing a second adhesive along the first edge of the plate to be disposed over a second portion of the optical fiber and a portion of the waveguide; and
curing at least one of the dispensed first adhesive or the dispensed second adhesive.

14. The method of claim 13, wherein dispensing the first adhesive along the second edge of the plate includes flowing the first adhesive:
into a first portion of the groove receiving the first portion of the optical fiber, and
between the plate and the surface of the PIC die.

15. The method of claim 14, further comprising:
prior to dispensing the second adhesive, curing the first adhesive to prevent the first adhesive from being disposed over the waveguide.

16. The method of claim 15, wherein dispensing the second adhesive along the first edge of the plate includes flowing the second adhesive:
into a second portion of the groove receiving the second portion of the optical fiber, and
between the plate and the surface of the PIC die, separated from the cured first adhesive.

17. The method of claim 13, further comprising:
applying a force to a top surface of the plate to press the optical fiber into the groove of the PIC die, the top surface of the plate extending between the first edge and the second edge.

18. The method of claim 13, wherein positioning the optical fiber within the groove includes positioning an end of the optical fiber within the groove directly adjacent the waveguide.

19. The method of claim 18, wherein positioning the plate over the optical fiber includes positioning the first edge of the plate adjacent the end of the optical fiber such that the end of the optical fiber is uncovered by the plate.

20. The method of claim 13, wherein the first adhesive is an ultraviolent (UV) curable adhesive, and the second adhesive is an optical adhesive configured to optically couple the optical fiber to the waveguide of the PIC die.
